(19) United States
(12) Patent Application Publication
(10) Pub. No.: US 2013/0098151 A1
(43) Pub. Date: Apr. 25, 2013

(54) CAPACITIVE SENSOR AND METHOD FOR MAKING THE SAME

(71) Applicants: Suraya Sulaiman, Kuala Lumpur (MY); Agus Santoso Tamsir, Kuala Lumpur (MY); Azrif Manut, Kuala Lumpur (MY); Dzuzlindah Muhamad Alias, Kuala Lumpur (MY); Azlina Mohd Zain, Kuala Lumpur (MY)

(72) Inventors: Suraya Sulaiman, Kuala Lumpur (MY); Agus Santoso Tamsir, Kuala Lumpur (MY); Azrif Manut, Kuala Lumpur (MY); Dzuzlindah Muhamad Alias, Kuala Lumpur (MY); Azlina Mohd Zain, Kuala Lumpur (MY)

(21) Appl. No.: 13/063,342

(22) PCT Filed: Sep. 3, 2009
(86) PCT No.: PCT/MY2009/000135

§ 371 Date: Nov. 5, 2012

(30) Foreign Application Priority Data
Sep. 10, 2008 (MY) PI 20083507

(51) Int. Cl. G01N 27/22

(52) U.S. Cl. CPC G01N 27/223
USPC 73/335.04; 427/79

(57) ABSTRACT

The present invention relates to capacitive sensors for measuring humidity and moisture and to an improved process for making the same. The fabrication process for a capacitive sensor having a multi-layer electrodes for measuring humidity and moisture comprising disposing the multi-layer interdigitated electrodes in a multi-layer polyimides; providing a plurality of trenches on the surface of the electrode by lift off process; and covering the sensor with photosensitive negative polyimide.

### FIELD OF THE INVENTION

The present invention relates to capacitive sensors for measuring humidity and moisture and to an improved process for making the same.

### BACKGROUND OF THE INVENTION

Humidity and moisture sensors are electrical instruments for determining the moisture content. Knowing the moisture content of materials is often very important. For example, soil moisture is fundamentally important to activities in agriculture, forestry, hydrology, and civil engineering. Therefore, an accurate and precise means of testing or measuring moisture content will help users to monitor the moisture content of soil and preferred moisture content can be achieved.

Because of the importance of knowing the moisture content of materials, various techniques have been developed to measure it. The capacitance type humidity sensor is based on variation of dielectric constants by hygroscopic property of an organic material such as polyimide.

The capacitance type humidity sensor detects humidity by measuring the change in the electrostatic capacity of an element corresponding to the ambient humidity. Capacitive sensors are typically made by depositing several layers of material on a substrate material. Humidity can be measured based upon the reversible water absorption characteristics of polymeric materials. The absorption of water into a sensor structure causes a number of physical changes in the active polymer. These physical changes can be transduced into electrical signals which are related to the water concentration in the polymer and which in turn are related to the relative humidity in the air surrounding the polymer. Polymeric films have been used as a humidity-sensing element.

A capacitive sensor, which detects humidity and moisture based on a change of capacitance between two detection electrodes provided on a semiconductor substrate, has two detection electrodes, which oppose each other, on a first insulation film formed on a surface of a semiconductor substrate. The detection electrodes are covered with a second insulation film and are further covered with a moisture sensitive film thereon.

There is disclosed in the U.S. Pat. No. 6,445,565B1, a capacitive sensor for measuring humidity and moisture using a single layer interdigitated silicon electrode with a coated layer of sensitive material (i.e. single polyimide layer). The surface of the sensor is covered with an insulator. The limitation of the sensor is that the ability of absorbing water and its sensitivity are low.

### SUMMARY OF THE INVENTION

It is an object of the present invention to alleviate the above disadvantages by providing a sensor and process for making the same with improved water absorption and sensitivity.

According to present invention, multi-layer interdigitated electrodes are provided to increase the total capacitance and the sensitivity of the sensor. Preferably aluminum layers are used for electrodes which are layered with insulating layers such as polyimide. A plurality of trenches is provided on the polyimide's surface to increase the total area for water absorption. Side walls between a first interdigitated electrode layer and a second interdigitated electrode layer are disposed perpendicular to the layers and not to overlap into each other to allow better absorption of water. The surface of the sensor is covered with a photosensitive negative polyimide. To fabricate the sensor according to the present invention, a moisture sensitive polymeric material such as photosensitive polyimide is used.

### BRIEF DESCRIPTION OF THE INVENTION

The present invention is described by way of example only, with reference to the accompanying drawings, in which:

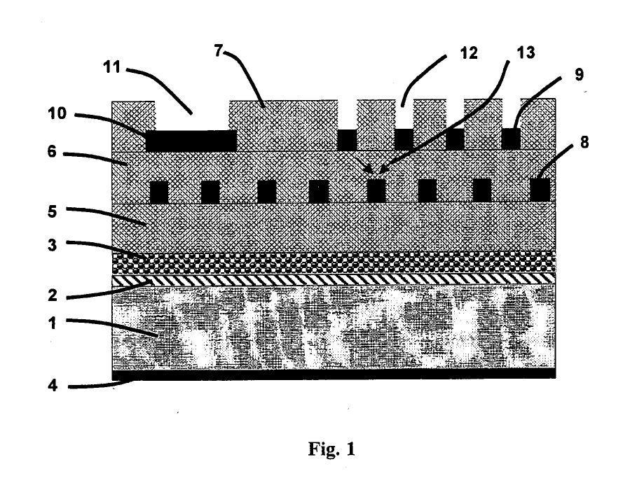

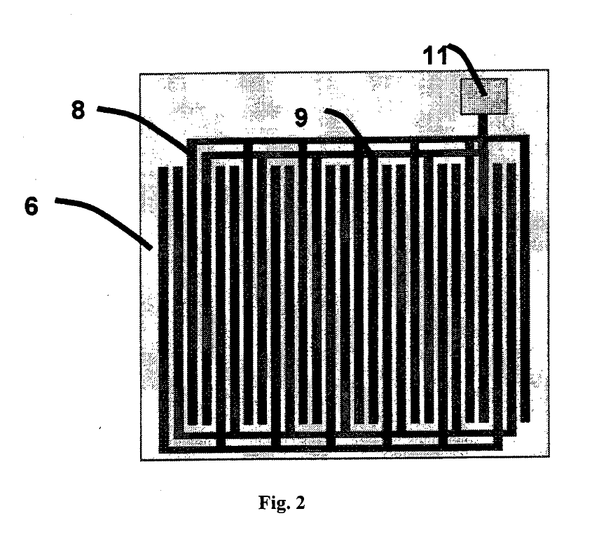

FIG. 1 shows a cross-section view of a side of a sensor for humidity and moisture according to the present invention having multi-layer electrodes;

FIG. 2 shows a top view of the sensor; and

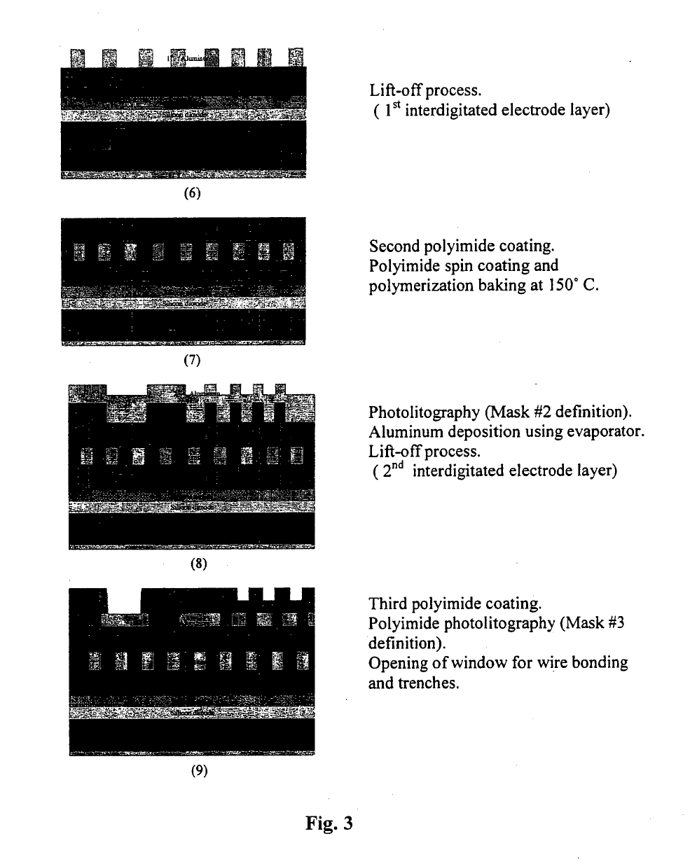

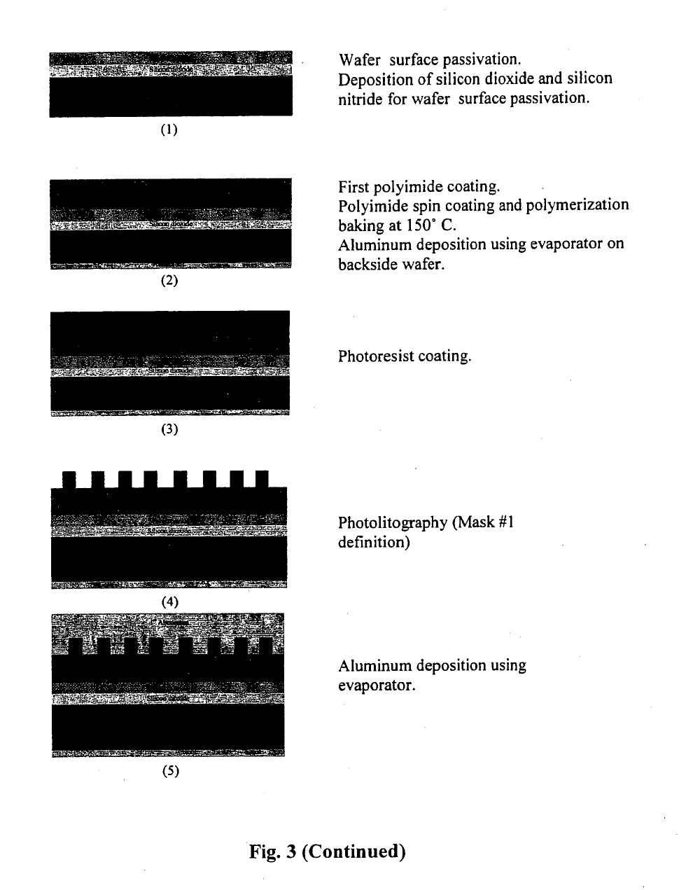

FIGS. 3 (1-9) show a fabrication process of the sensor.

### DETAILED DESCRIPTION OF THE INVENTION

According to the present invention, a sensor for measuring humidity and moisture, comprises a plurality of interdigitated electrodes. The electrodes are disposed in a plane of an insulating layer of polyimide. As illustrated in FIG. 1, the sensor comprises layers of silicon wafer substrate (1), silicon dioxide (2), silicon nitride (3), backside aluminum (4), first polyimide (5), second polyimide (6), third polyimide (7), first interdigitated electrodes (8), second interdigitated electrodes (9), wire bonding pad (10), wire bonding window (11), trenches (12) on the upper layer of the polyimide, and to side walls (13) in between the first and second interdigitated electrodes. The trenches and the side walls increase the water absorption area of the sensor.

The first interdigitated electrodes (8) are disposed in the second polyimide layer (6) whereas the second interdigitated electrodes (9) are disposed in the third polyimide layer (7). A plurality of trenches (12) is provided on the third polyimide layer (7) to increase area for water absorption. The side walls (13) between the first interdigitated electrodes (8) and second interdigitated electrodes (9) are arranged to be perpendicular to and not to be overlapped into each other to increase water absorption of the polyimides.

FIG. 2 shows the top view of the sensor showing the arrangement of the first interdigitated electrodes (8) and the second interdigitated electrodes (9) in the second polyimide layer (6) and the window (11) of the wire-bonding pad. The FIGS. 1 and 2 show a sensor having double-layer electrodes. The sensor can be designed to have multi-layer electrodes.

The measurement of humidity and moisture is based on dielectric properties of the insulating and semi-insulating materials from one-side of the sensor.

During the fabrication process, the exposure, development and bake time is optimized. FIG. 3 shows a fabrication process of the sensor using three layers of polyimide. The lower polyimide layer is provided to isolate the electrodes from substrate. The second and third (upper) layers act as sensitive material. Opening windows for wire bonding is provided on the upper layer.

Three masks are needed for this fabrication process. The first and second masks are for electrode layers definition whereas the third mask is for wire bonding definition. Preferably, photosensitive negative polyimide such as pyralin PI2723 is used for the sensor. A light source of G-line type is needed for UV exposure during photolithography process of the pyralin. Pyralin is known for high water absorption factor.

The fabrication process of the sensor is shown in FIGS. 3 (1-9)

First, a substrate is provided as shown in FIG. 3(1). The substrate comprises silicon wafer substrate (1) layered with silicon dioxide (2) and silicon nitride for protecting the silicon wafer substrate's surface. Next aluminum layer (4) is layered on the backside of the silicon wafer substrate (1) to bias the substrate for minimizing capacitance depletion as shown in FIG. 3(2).

Next, the first polyimide layer (5) is coated on the substrate and polymerized by baking the polyimide layer at a temperature preferably at 150 degrees Celsius for about 30 minutes. Positive photoresist such as AZ4620 is coated on the cured polyimide. The photoresist coating is shown in FIG. 3(3). AZ400k developer can be used in photolithography. A layer of aluminum is deposited using evaporator and lift off process to form a patterned aluminum coating on the cured polyimide's surface for a first electrodes definition (first mask) as shown in FIGS. 3(4,5 and 6).

The second polyimide layer (6) is then coated and polymerized by baking the polyimide layer at a temperature preferably at 150 degree celsius for about 30 minutes as shown in FIG. 3 (7). Positive photoresist such as AZ4620 is then coated on the cured polyimide. AZ400K developer to form a patterned aluminum coating on the cured polyimide's surface for the second electrodes definition (second mask) as shown in FIG. 3 (8).

Next, aluminium layer (9) is deposited using evaporator (9) for second lifting off process as shown in FIG. 3(8). The third polyimide layer (7) is then coated on top of the second polyimide whereby the aluminum layer is patterned and developed using DE6180 developer and RI9180 rinser for third mask for wire bonding (11) and trenches (12) definitions as shown in FIG. 3 (9).

To fabricate a subsequent layer of interdigitated electrodes and polyimides, positive photoresist such as AZ4620 is coated on a subsequent cured polyimide during photolithography using AZ400k developer to form a subsequent patterned aluminum coating on the subsequent cured polyimide's surface for a subsequent electrodes layer.

Finally, the sensor is cured at a temperature preferably at 350 degrees Celsius for 45 minutes to ensure complete imidization of the polyimide. The fabrication process of the sensor is now complete and ready for wire bonding.

1. A fabrication process for a capacitive sensor having multi-layer electrodes for
measuring humidity and moisture comprising
disposing the multi-layer interdigitated electrodes in a multi-layer polyimides;
providing a plurality of trenches on the surface of the electrode by lift off process; and
covering the sensor with photosensitive negative polyimide.

2. A fabrication process as claimed in claim 1 wherein the disposing of the multi-layer interdigitated electrodes is by depositing aluminum layers on the multi-layer polyimides which has been cured.

3. A fabrication process as claimed in claim 2 wherein the multi-layer polyimides is cured at a baking temperature about 150 degrees celsius for about 30 minutes.

4. A fabrication process as claimed in claim 1 wherein positive photoresist such as AZ4620 is coated on the cured polyimide during photolithography using AZ400k developer to form a patterned aluminum coating on the cured polyimide's surface for a first electrodes layer.

5. A fabrication process as claimed in claim 1 wherein positive photoresist such as AZ4620 is coated on a subsequent cured polyimide during photolithography using AZ400k developer to form a subsequent patterned aluminum coating on the subsequent cured polyimide's surface for a subsequent electrodes layer.

6. A capacitive sensor for measuring humidity and sensor comprises at least
layers of silicon wafer substrate, silicon dioxide, silicon nitride, backside aluminum, first polyimide, second polyimide, third polyimide, first interdigitated electrodes, second interdigitated electrodes, wire bonding pad, wire bonding window, trenches' on the upper layer of the polyimide, and side walls in between the layer of the first and second interdigitated electrodes.

7. The capacitive sensor as claimed in claim 6 wherein the trenches and the side walls increase the water absorption area of the sensor.
